(19) United States
(12) Patent Application Publication
(10) Pub. No.: US 2011/0258810 A1
(43) Pub. Date: Oct. 27, 2011

(54) HINGE

(75) Inventor: CHEN-WEI CHIANG, Tu-Cheng (TW)

(73) Assignee: HON HAI PRECISION INDUSTRY CO., LTD., Tu-Cheng (TW)

(21) Appl. No.: 12/843,074

(22) Filed: Jul. 26, 2010

(30) Foreign Application Priority Data
Apr. 23, 2010 (TW) 99112778

(51) Int. Cl. E05F 1/12

(52) U.S. Cl. 16/297

(57) ABSTRACT

A hinge includes a fixing bracket having a pole, a rotating bracket, a connecting member, a clamping member, and a male element rotatably sleeved on the pole. The hinge further includes a female element non-rotatably mounted to the pole, an elastic assembly rotatably sleeved on the shaft post, and a fastener fixed to a distal end of the pole. The connecting member is fixed to the rotating bracket. The clamping member is fixed to the connecting member, and the male element is fixed to the clamping member. The hinge further includes a first friction washer located between the rotating bracket and the connecting member, a second friction washer located between the connecting member and the clamping member, and a third friction washer located between the clamping member and the male element.

### BACKGROUND

1. Technical Field

The disclosure relates to a hinge.

2. Description of Related Art

A collapsible device, such as a notebook computer, or a clamshell mobile phone, generally includes a main body hinged to a display.

A hinge normally includes a first element and a second element fixed to the main body and the cover of the collapsible device, respectively. The first and second elements are rotatable relative to and in frictional engagement with each other for maintaining the cover at any angle with respect to the main body. However, if the friction between the first and second elements is not enough, the cover cannot maintain stability at certain desired positions with respect to the main body, which creates quite an inconvenience for users.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a hinge.

FIG. 2 is similar to FIG. 1, but viewed from another perspective.

FIG. 3 is an assembled, isometric view of the hinge of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

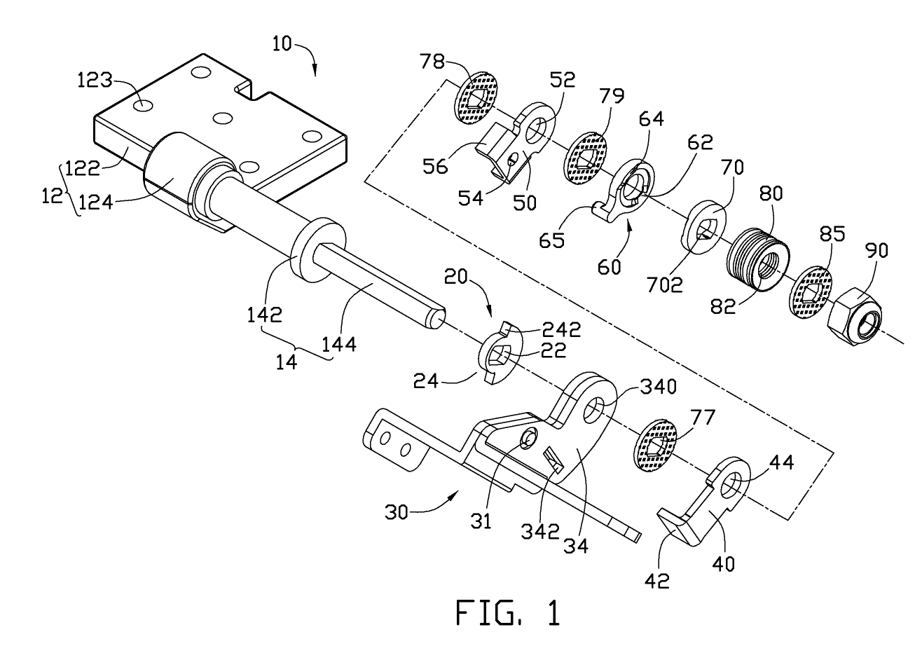

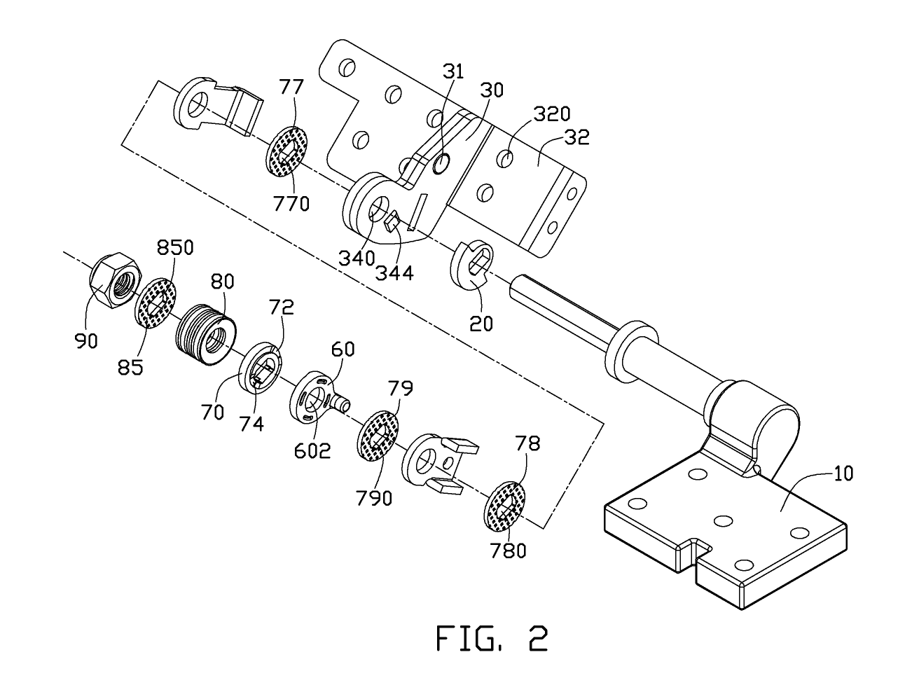

Referring to FIGS. 1 and 2, in an exemplary embodiment, a hinge includes a fixing bracket 10, a resisting member 20, two rotating brackets 30, a connecting member 40, and a clamping member 50. A male element 60, a female element 70, a first friction washer 77, a second friction washer 78, a third friction washer 79, an elastic assembly 80, a gasket 85, and a fastener 90 are also included. In this embodiment, the fastener 90 is a nut.

The fixing bracket 10 includes a bracket 12, and a shaft 14 extending from the bracket 12. The bracket 12 includes a connecting board 122 defining a plurality of fixing holes 123 therein, and a fixing portion 124 extending from a side of the connecting board 122. The shaft 14 extends from the fixing portion 124, and includes a shoulder 142, and a substantially double D-shaped pole 144 axially extending from the shoulder 142, away from the fixing portion 124.

The resisting member 20 defines a double-D shaped shaft hole 22 in a center of the resisting member 20, corresponding to the pole 144 of the fixing bracket 10, for non-rotatably fitting about the pole 144 of the fixing bracket 10. The resisting member 20 defines an arc-shaped cutout 24 along a circumference, and each of opposite ends of the cutout 24 forms a resisting surface 242.

Each rotating bracket 30 is generally L-shaped. The rotating bracket 30 includes a fixing arm 32 defining a number of fixing holes 320 therein, and a pivoting portion 34 perpendicularly extending from an end of the fixing arm 32. The pivoting portion 34 defines a through hole 340 and a fixing slot 342. Wherein, a protrusion 344 protrudes from a side of the pivoting portion 34 facing the resisting member 20, adjacent to the corresponding through hole 340. In this embodiment, the pivoting portions 34 of the rotating brackets 30 abut against each other, and then, a bolt 31 fixes the pivoting portions 34 together, with the fixing slots 342 aligning in a line. In other embodiments, the two rotating brackets 30 are integrally formed with each other, or the hinge includes only one rotating bracket 30.

The first, second, and third friction washers 77, 78, and 79 are similar to one another. Each of the first, second, and third friction washers 77, 78, and 79 defines a double-D shaped fixing hole 770, 780, and 790 in a center thereof, through which the pole 144 of the fixing bracket 10 non-rotatably extends.

The connecting member 40 defines a round hole 44 adjacent to a first end of the connecting member 40. A fixing tab 42 perpendicularly extends from a second end of the connecting member 40, opposite to the first end of the connecting member 40.

The clamping member 50 defines a through hole 52 in a first end of the clamping member 50, and a clamping hole 54 in a second end of the clamping member 50 opposite to the first end of the clamping member 50. Two clamping tabs 56 extend from opposite sides of the second end of the clamping member 50, for clamping opposite sides of the connecting member 40 to force the clamping member 50 to rotate with the connecting member 40.

The male element 60 is generally washer shaped. The male element 60 defines a through hole 602 in a center of the male element 60, through which the pole 144 of the fixing bracket 10 rotatably extends. A first raised portion 62 and a second raised portion 64 protrude from a first side of the male element 60. The first raised portion 62 and the second raised portion 64 are opposite each other, across the through hole 602. The first raised portion 62 is adjacent to an edge bounding the through hole 602, and the second raised portion 64 is adjacent to a circumference of the male element 60. A protrusion (not labeled) extends from the circumference of the male element 60, with a fixing post 65 extending from the protrusion, opposite to the first and second raised portions 62 and 64.

The female element 70 is generally washer shaped. The female element 70 defines a double-D shaped mounting hole 702 in the center of the female element 70, through which the pole 144 of the fixing bracket 10 non-rotatably extends. The female element 70 defines a first depressed portion 72 adjacent to an edge bounding the mounting hole 702, and a second depressed portion 74 adjacent to a circumference of the female element 70. The first and second depressed portions 72 and 74 are opposite each other, across the mounting hole 702.

The elastic assembly 80 includes a plurality of elastic rings (not labeled) arranged in a line and resisting against each other. Each elastic ring defines a round through hole 82, allowing the pole 144 of the fixing bracket 10 to rotatably pass therethrough. The elastic assembly 80 provides elasticity along an axis of the pole 144, to tighten the female element 70, the male element 60, the clamping member 50, the connecting member 40, the first, second and third friction washers 77, 78, and 79, the rotating brackets 30, and the resisting member 20.

The gasket 85 defines a substantially double-D shaped fixing hole 850 in a center of the gasket 85, through which the pole 144 of the fixing bracket 10 non-rotatably extends.

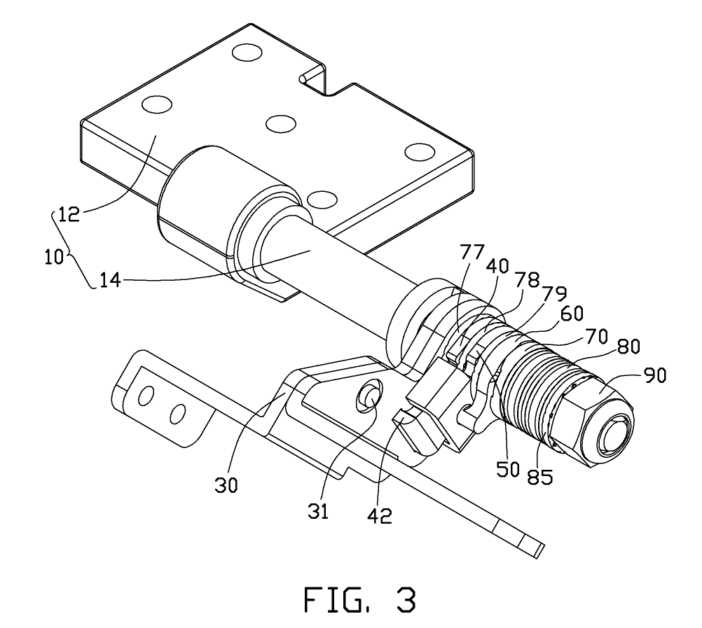

Referring to FIG. 3, in assembly, the pole 144 of the fixing bracket 10 is extended through the shaft hole 22 of the resisting member 20, the through holes 340 of the rotating brackets 30, the fixing hole 770 of the first friction washer 77, the round hole 44 of the connecting member 40, the fixing hole 780 of the second friction washer 78, the through hole 52 of the clamping member 50. As well as, the pole 144 is extended through the fixing hole 790 of the third friction washer 79, the through hole 602 of the male element 60, the mounting hole 702 of the female element 70, the through holes 82 of the elastic assembly 80, and the fixing hole 850 of the gasket 85 one by one in that order, with the distal end of the pole 144 engaging in the fastener 90 for preventing the gasket 85, the female element 70, the male element 60, the clamping member 50, the connecting member 40, the first, second and third friction washers 77, 78, and 79, the rotating brackets 30, and the resisting member 20 from disengaging from the pole 144. In this state, the resisting member 20 resists against the shoulder 142 of the fixing bracket 10. The protrusion 344 of one of the rotating brackets 30 is received in the cutout 24 of the resisting member 20, and resists against one of the resisting surfaces 242 of the resisting member 20. The fixing tab 42 of the connecting member 40 is engaged in the fixing slots 342 of the rotating brackets 30. The clamping tabs 56 of the clamping member 50 fixedly clamp the connecting member 40. The fixing post 65 of the male element 60 is fixed in the clamping hole 54 of the clamping member 50. Therefore, the connecting member 40, the clamping member 50, and the male element 60 can be rotated together with the rotating brackets 30. The first and second raised portions 62 and 64 of the male element 60 are received in the first and second depressed portions 72 and 74 of the female element 70. The first friction washer 77 is sandwiched between one of the rotating brackets 30 and the connecting member 40. The second friction washer 78 is sandwiched between the connecting member 40 and the clamping member 50. The third friction washer 79 is sandwiched between the clamping member 50 and the male element 60.

In use, the above-mentioned hinge can be utilized in a collapsible device (not shown), such as a notebook computer, that includes a base (not shown) and a cover (not shown) hinged to the base. The rotating brackets 30 are fixed to the cover with the fixing holes 320. The fixing bracket 10 is correspondingly fixed to the base with the fixing holes 123. During the opening of the cover, the cover is rotated relative to the base, so that the rotating brackets 30 are rotated relative to the pole 144 of the fixing bracket 10, together with the connecting member 40, the clamping member 50, and the male element 60. In this process, the first and second raised portions 62 and 64 of the male element 60 are slid out of the first and second depressed portions 72 and 74 of the female element 70, to urge the elastic assembly 80. The rotating brackets 30, the connecting member 40, the clamping member 50, and the male element 60 are relative to and in frictional engagement with the first, second, and third friction washers 77, 78, and 79, correspondingly, to increase friction of the hinge to stably maintain the cover at certain desirable positions with respect to the base.

When the rotating brackets 30 are rotated to a predetermined degree relative to the fixing bracket 10, the protrusion 344 of one of the rotating brackets 30 resists against the other resisting surface 242 of the resisting member 20. Therefore, the rotating brackets 30 cannot be rotated further relative to the fixing bracket 10. As a result, the cover is stably maintained at the predetermined degree with respect to the base, preventing the cover from over-rotating.

In other embodiments, the hinge can further include more than three friction washers located between the rotating bracket 30, the connecting member 40, the clamping member 50, and the male element 60, to increase friction.

In other embodiments, the male and female elements 60 and 70 can be omitted, and the third friction washer 79 is located between the clamping member 50 and one end of the elastic assembly 80.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. A hinge comprising:
a fixing bracket comprising a pole;
a rotating bracket rotatably sleeved on the pole;
a connecting member rotatably sleeved on the pole, and fixed to the rotating bracket;
a clamping member rotatably sleeved on the pole, and clamped to the connecting member;
a male element rotatably sleeved on the pole, and fixed to the clamping member;
a female element non-rotatably mounted to the pole, and rotatable relative to the male element;
first to third friction washers all non-rotatably sleeved on the pole, wherein the first friction washer is sandwiched between the rotating bracket and the connecting member, the second friction washer is sandwiched between the connecting member and the clamping member, and the third friction washer is sandwiched between the clamping member and the male element;
an elastic assembly rotatably sleeved on the shaft post, to provide elasticity along an axis of the pole to tighten the connecting member, the clamping member, the male element, the female element, and the rotating bracket; and
a fastener fixed to a distal end of the pole.

2. The hinge of claim 1, wherein the rotating bracket defines a fixing slot, a fixing tab extends from the connecting member to engage in the fixing slot.

3. The hinge of claim 1, wherein two clamping tabs extend from opposite sides of the clamping member, to fixedly clamp opposite sides of the connecting member.

4. The hinge of claim 1, wherein the clamping member defines a clamping hole, a fixing post protrudes from the male element to engage in the clamping hole.

5. The hinge of claim 4, wherein the male element defines a through hole, through which the pole rotatably extends, a first raised portion and a second raised portion protrude from the male element, opposite to the fixing post.

6. The hinge of claim 5, wherein the first raised portion is adjacent to an edge bounding the through hole, the second raised portion is adjacent to a circumference of the male element, opposite to the first raised portion across the through hole, the female element defines a first depressed portion and a second depressed, slidably received in corresponding first and second raised portions.

7. The hinge of claim 1, wherein the rotating bracket defines a through hole, through which the pole rotatably extends, a protrusion protrudes from the rotating bracket, a resisting member non-rotatably mounted to the pole comprises two resisting surfaces, the protrusion selectively resists against one of the resisting surfaces.

8. The hinge of claim 7, wherein the rotating bracket further defines a fixing slot, the connecting member defines a round hole for the pole rotatably passing therethrough, a fixing tab away from the round hole, extends from the connecting member to engage in the fixing slot.

9. The hinge of claim 8, wherein the clamping member defines a through hole for the pole rotatably passing therethrough, two clamping tabs extend from opposite sides of the clamping member, to fixedly clamp opposite sides of the connecting member.

10. The hinge of claim 8, wherein the clamping member further defines a clamping hole, a fixing post protrudes from the male element to engage in the clamping hole.
